(19) United States
(12) Patent Application Publication
(10) Pub. No.: US 2023/0138902 A1
(43) Pub. Date: May 4, 2023

(54) DEVICE THAT IMPLEMENTS A CRYOGENIC SPACE ENVIRONMENT THAT USES ROOM TEMPERATURE NITROGEN GAS AND CONTROLS TEMPERATURE

(71) Applicant: KOREA AEROSPACE RESEARCH INSTITUTE, Daejeon (KR)

(72) Inventors: Hyokjin CHO, Daejeon (KR); Sung-Wook PARK, Daejeon (KR); Sang-Hoon LEE, Daejeon (KR); Hee-Jun SEO, Daejeon (KR); Soohwan JUN, Sejong-si (KR); Hye-Jin YI, Daejeon (KR)

(21) Appl. No.: 18/051,829

(22) Filed: Nov. 1, 2022

(30) Foreign Application Priority Data
Nov. 1, 2021 (KR) 10-2021-0147906

(51) Int. Cl. B64G 1/50; F17C 7/04

(52) U.S. Cl. CPC B64G 1/50; F17C 7/04; F17C 2250/032; F17C 2250/0626; F17C 2250/0631; F17C 2250/0439; F17C 2227/0353; F17C 2221/014; F17C 2250/0694; F17C 2223/0161; F17C 2270/0194

(57) ABSTRACT

Provided is a device for implementing a space environment. More specifically, in order to implement a space environment, while a shroud is disposed inside a vacuum container, an internal pressure of the shroud is controlled to adjust a saturation temperature of working fluid by forming a closed system including a cryogenic refrigerator. As a result, the environment can be implemented at a required temperature. At this time, the pressure can be adjusted by supplying room-temperature gas as working fluid into the closed system, which may result in costs being reduced because there is no need to manage a liquid bombe, and the working fluid injected inside can be used in a recycled manner.

### CROSS-REFERENCE TO RELATED APPLICATION

The present application claims priority to Korean Patent Application No. 10-2021-0147906 filed on Nov. 1, 2021. The entire contents of the above-listed application are hereby incorporated by reference for all purposes.

### TECHNICAL FIELD

The following disclosure relates to a device for implementing a space environment, and more particularly, to a device for implementing a cryogenic space environment capable of controlling a temperature in a vacuum-state container to be maintained in a cryogenic state to implement a space environment.

### BACKGROUND

A device for implementing a space environment is a device for implementing the inside of a vacuum-state container to become a state close to a space environment to perform a test for checking an operation of a test object, such as an artificial satellite, before being launched into an outer space.

FIG. 1 is a schematic diagram of a conventional device for implementing a space environment. Referring to FIG. 1, a vacuum state of a vacuum container is maintained by a vacuum pump connected to the vacuum container, and a shroud is disposed inside the vacuum container. The shroud has a structure in which liquid nitrogen is supplied thereto through a liquid nitrogen tank connected to the shroud, and the supplied liquid nitrogen is discharged to the outside in a gas phase after exchanging heat with the inside of the vacuum container.

In the conventional device for implementing a cryogenic space environment, the space environment is implemented by directly supplying liquid nitrogen to the shroud inside the vacuum container. In order to supply liquid nitrogen, which is cryogenic fluid, a separate fluid storage container (e.g., a liquid nitrogen tank), which is difficult to handle and manage, is required. Furthermore, since a system to which the liquid nitrogen is supplied is exposed to the outside, a temperature can be restrictively maintained only at −196 degrees Celsius, which is a saturation temperature of liquid nitrogen at atmospheric pressure.

Therefore, there has been a demand for a technique capable of implementing a cryogenic temperature environment, while controlling the cryogenic temperature environment at a temperature in a predetermined range and replacing a liquid nitrogen tank that is difficult to manage.

### SUMMARY

An embodiment of the present disclosure is directed to providing a device for implementing a cryogenic space environment by controlling a temperature of working fluid that determines a temperature of a shroud.

Another embodiment of the present disclosure is directed to providing a device for implementing a cryogenic space environment by supplying room-temperature gas instead of liquid nitrogen that is difficult to manage.

Another embodiment of the present disclosure is directed to providing a device for implementing a cryogenic space environment by configuring a closed system for liquefying gas supplied to be injected into a shroud and controlling a saturation temperature of working fluid.

In one general aspect, a device for implementing a space environment includes: a vacuum container maintaining a vacuum state through a vacuum pump; a shroud disposed inside the vacuum container to exchange heat between working fluid supplied into the shroud and the inside of the vacuum container; a liquefaction tank connected to both ends of the shroud and including a cryogenic refrigerator liquefying working fluid; a pressure tank connected to an upper end of the liquefaction tank to supply or discharge gas-phase working fluid to or from the liquefaction tank; and a control device controlling a pressure of the pressure tank, by supplying or discharging working fluid to or from the pressure tank, to adjust a saturation temperature of the working fluid.

A closed system may be maintained inside the shroud, and radiant heat may be exchanged between the working fluid supplied into the shroud and the inside of the vacuum container.

The liquefaction tank may be connected to both ends of the shroud, including: a gas line connected to the upper end of the liquefaction tank to supply vaporized working fluid from the shroud to the liquefaction tank; and a liquid line connected to a lower end of the liquefaction tank to supply liquefied working fluid from the liquefaction tank to the shroud, the liquefaction tank may be disposed above the shroud, and the liquefied working fluid may move in a gravity direction and be injected into the shroud.

A plurality of temperature sensors may be disposed along the shroud in the vacuum container, and the plurality of temperature sensors may be disposed to be spaced apart from one another at predetermined intervals from the liquid line to a lower side of the shroud to measure a location-based change in temperature of working fluid.

One or more cryogenic refrigerators may be disposed in the liquefaction tank, and the cryogenic refrigerators may be controlled according to an internal temperature of the vacuum container.

Gas-phase working fluid may be supplied from a bombe to the pressure tank to increase an internal pressure of the pressure tank.

The pressure tank may be connected to an exhaust line connected to the outside and a supply line connected to the bombe, the pressure of the pressure tank may be input to the control device, and the control device may output whether to open or close an exhaust valve of the exhaust line and a supply valve of the supply line.

The bombe may contain nitrogen gas at room temperature.

The control device may include a calculation unit calculating the saturation temperature of the working fluid through a pressure sensor connected to the pressure tank.

The shroud may maintain a temperature of the working fluid in a range between a triple point temperature and a critical temperature by adjusting a saturation pressure of the fluid in the closed system.

In another general aspect, a method for implementing a space environment using the device for implementing a space environment includes: a pressure control step in which the control device controls a pressure of the closed system by supplying or discharging fluid to or from the pressure tank; after the pressure control step, a liquefaction step in which the cryogenic refrigerator liquefies the supplied working fluid; after the liquefaction step, an inflow step in which the liquefied working fluid moves in a gravity direction and flows into the shroud; and after the inflow step, a heat exchange step in which radiant heat is exchanged between the shroud and the inside of the vacuum container.

The pressure control step may include: a depressurization step in which the working fluid is discharged to the outside to decrease the pressure in the closed system; and a pressurization step in which working fluid for pressurization is supplied from a bombe containing the working fluid at room temperature to increase the pressure in the closed system.

In the liquefaction step, the saturation temperature of the working fluid may be changed according to the pressure adjusted in the pressure control step.

The method for implementing a space environment may further include, after the heat exchange step, a regeneration step in which the working fluid subjected to the heat exchange is vaporized, the vaporized working fluid moves to the liquefaction tank, and then the liquefaction step is repeated.

According to the present disclosure, a temperature inside the vacuum container can be adjusted by controlling a temperature of working fluid that determines a temperature of the shroud.

In addition, by providing the cryogenic refrigerator for liquefying gas, room-temperature gas can be supplied instead of liquid nitrogen that is difficult to manage.

In addition, a temperature inside the vacuum container can be formed within a predetermined range by configuring a closed system in the shroud and controlling a pressure in the closed system to control a saturation temperature of working fluid.

### BRIEF DESCRIPTION OF THE DRAWINGS

FIG. 1 is a configuration diagram illustrating a conventional art.

FIG. 2 is a configuration diagram illustrating the present disclosure.

FIG. 3, FIG. 4, and FIG. 5 are enlarged diagrams illustrating the present disclosure.

FIG. 6 is a phase-change graph.

### DETAILED DESCRIPTION

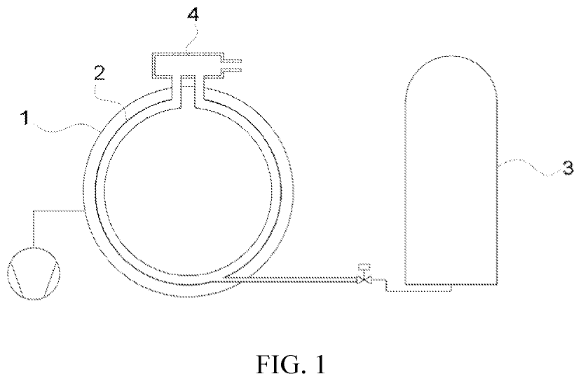

Referring to FIG. 1, in a conventional device for implementing a space environment, a temperature inside a vacuum-state container 1 is decreased by supplying liquid nitrogen into a shroud 2. At this time, since the shroud 2 is exposed to atmospheric-pressure outside air through a chamber 4, the temperature can be maintained only at −196 degrees Celsius, which is a saturation temperature, and thus, it is difficult to control the temperature.

In addition, the conventional device for implementing a space environment is disadvantageous in that it is required to continuously supply liquid nitrogen, and it is also required to manage a bombe 3 containing liquid nitrogen and connected to supply the liquid nitrogen.

The present disclosure provides a device for implementing a space environment capable of controlling a temperature in a shroud and a vacuum container by controlling a pressure to control a saturation temperature of gas-phase working fluid.

In addition, the present disclosure provides a device for implementing a space environment including a cryogenic refrigerator for liquefying room-temperature gas supplied thereto from a bombe, making it possible to reduce time and labor required to manage the bombe.

Hereinafter, a device for implementing a cryogenic space environment capable of controlling a temperature using room-temperature nitrogen gas according to the present disclosure having the configuration as described above will be described in detail with reference to the accompanying drawings.

### [1] Overall Configuration and Operating Principle of Present Disclosure

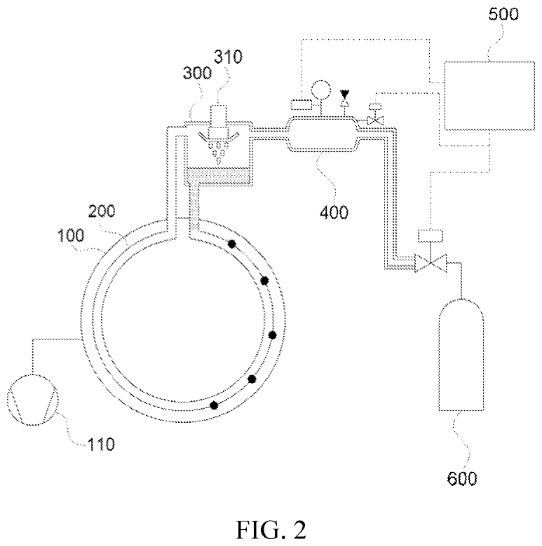

First, FIG. 2 is a configuration diagram illustrating the present disclosure. Referring to FIG. 2, the device for implementing a space environment includes: a vacuum container 100 maintaining a vacuum state through a vacuum pump 110; a shroud 200 disposed inside the vacuum container 100 to exchange heat between working fluid supplied into the shroud 200 and the inside of the vacuum container 100; a liquefaction tank 300 connected to both ends of the shroud 200 and including a cryogenic refrigerator 310 liquefying working fluid; a pressure tank 400 connected to an upper end of the liquefaction tank 300 and stably maintaining a pressure therein before supplying or discharging gas-phase working fluid; and a control device 500 controlling the pressure of the pressure tank 400, by supplying and discharging working fluid, to adjust a saturation temperature of the working fluid.

The vacuum container 100 is connected to the vacuum pump 110 disposed outside the vacuum container 100 to maintain the inside of the vacuum container 100 in a vacuum state and to implement the inside of the vacuum container 100 to have a pressure similar to that in the space environment. The inside of the vacuum container 100 is implemented to have a temperature similar to that in the space environment by exchanging radiant heat with the shroud 200 disposed inside the vacuum container 100.

The shroud 200 disposed in the vacuum container 100 is formed in the form of a tube to which working fluid for exchanging heat with the inside of the vacuum container 100 is supplied. Liquid-phase working fluid is supplied to the shroud 200 through one end thereof, and gas-phase working fluid is discharged from the shroud 200 after heat exchange through the other end thereof. Both ends of the shroud 200 according to the present disclosure are connected to one tank, and the supplying and the discharging of the working fluid are performed simultaneously.

The liquefaction tank 300 is connected to both ends of the shroud 200. A liquid line through which liquid-phase working fluid is supplied is connected to a lower end or a lower surface of the liquefaction tank 300, and a gas line through which gas-phase working fluid is discharged is connected to an upper end or an upper surface of the liquefaction tank 300. The cryogenic refrigerator 310 liquefying gas-phase working fluid is contained inside the liquefaction tank 300 to liquefy gas-phase working fluid in the liquefaction tank and collect liquid-phase working fluid at the lower end of the liquefaction tank. The collected liquid-phase working fluid is supplied into the shroud 200 through the liquid line.

The shroud 200, the liquefaction tank 300, and the pressure tank 400 are connected to one another, and a closed system is maintained therebetween. The pressure tank 400 is a tank for controlling a pressure of the closed system by supplying and discharging gas-phase working fluid. The pressure tank 400 is connected to the liquefaction tank 300 through a connection line, and is connected to the upper end or the upper surface of the liquefaction tank 300 to prevent the liquefied working fluid from moving.

In this case, it is a feature of the present disclosure to adjust a temperature of working fluid supplied into the shroud 200 by controlling a pressure of the closed system to change a saturation temperature of the working fluid to a required temperature.

This results in the ability to implement a space environment even at a temperature higher or lower than −196° C., without having to maintain the vacuum container 100 at a constant temperature (−196° C.).

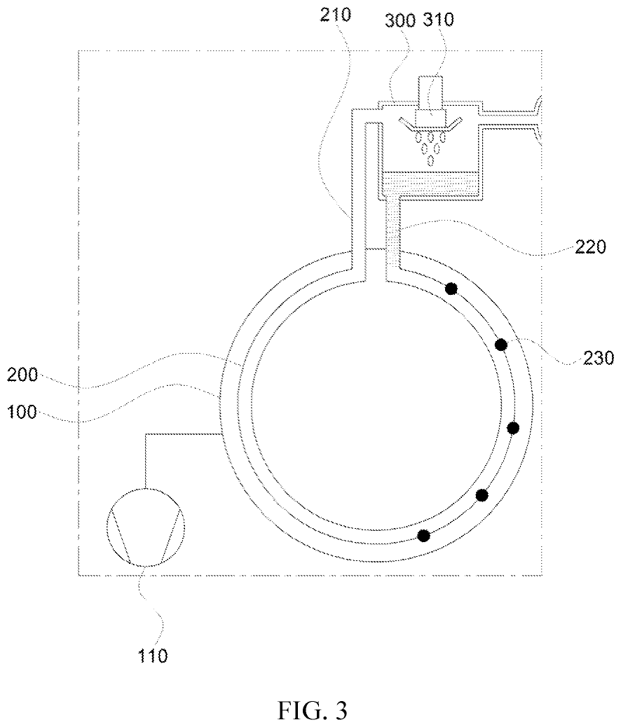

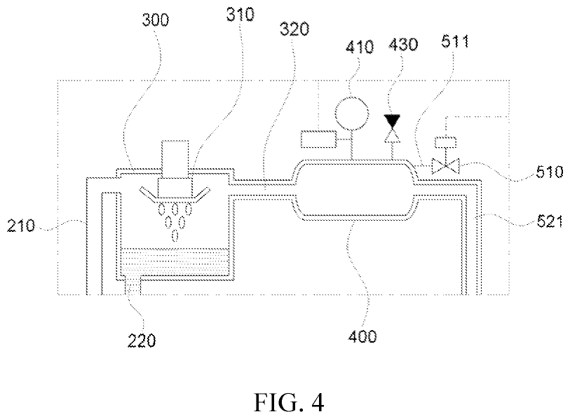

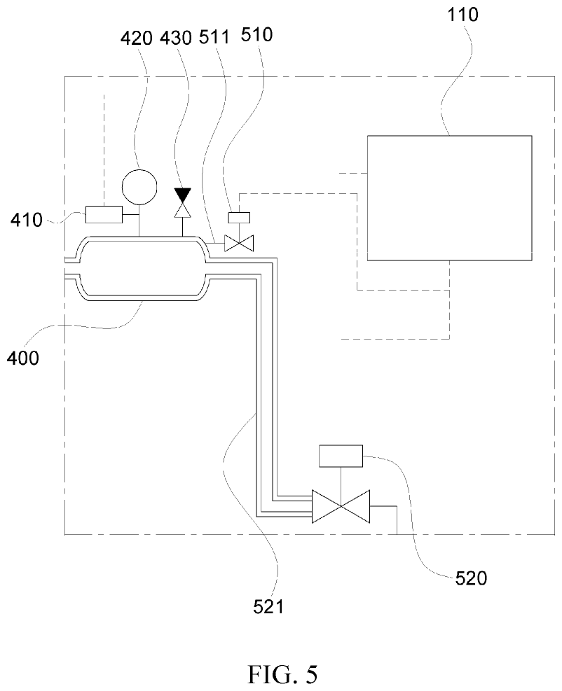

FIGS. 3 to 5 are enlarged views illustrating the present disclosure. FIG. 3 is an enlarged view illustrating the shroud and the liquid tank. Referring to FIG. 3, the liquefaction tank 300 is connected to both ends of the shroud 200, including a gas line 210 connected to the upper end of the liquefaction tank 300 to supply vaporized working fluid from the shroud 200 to the liquefaction tank 300 and a liquid line 220 connected to the lower end of the liquefaction tank 300 to supply liquefied working fluid from the liquefaction tank 300 to the shroud 200.

The liquefaction tank 300 is disposed above the shroud 200 so that the liquefied working fluid moves in a gravity direction to be injected through the liquid line 220 connected to the lower surface or the lower end of the liquefaction tank 300. This may reduce the number of components because a pump or the like for supplying working fluid into the shroud 200 is not necessary, thereby simplifying the configuration. Accordingly, it is possible to reduce costs and decrease generation of heat.

A plurality of temperature sensors 230 are disposed inside the vacuum container 100, some of the temperature sensors 230 are disposed along an outer surface of the shroud 200. The temperature sensors 230 are disposed to be spaced apart from one another at predetermined intervals from the liquid line 220 to a lower side of the shroud 200 to measure a location-based change in temperature of working fluid. The positions of the temperature sensors 230 are not limited thereto, and the temperature sensors 230 may be disposed to be spaced apart from the shroud 200 by a predetermined distance, and may be disposed from the lower side of the shroud 200 to the gas line 210.

By observing an internal temperature of the vacuum container and a change in temperature of the injected working fluid, the temperature of the supplied working fluid can be controlled to implement a required temperature environment within a short period time.

FIG. 4 is an enlarged view illustrating the liquefaction tank and the pressure tank. Referring to FIG. 4, the liquefaction tank 300 is connected to the liquid line 220 and the gas line 210 of the shroud 200, and the connection line 320 is connected to the upper end of the liquefaction tank 300 to be connected to the pressure tank 400. The pressure tank 400 is connected to a gas exhaust line 511 for discharging gas-phase working fluid to the outside and a gas supply line 521 for supplying gas-phase working fluid. Each of the gas exhaust line 511 and the gas supply line 521 is blocked from the outside by a valve to form a closed system inside.

The cryogenic refrigerator 310 is disposed at the upper end of the liquefaction tank 300 to liquefy gas-phase working fluid supplied through the gas line 210 and the connection line 320 connected to the upper end of the liquefaction tank 300. One or more cryogenic refrigerators 310 are disposed in the liquefaction tank 300, and the number of cryogenic refrigerators 310 to be operated and an operation time thereof are controlled according to the internal temperature of the vacuum container 100. When a difference between a required temperature and a current internal temperature of the vacuum container 100 is large, the number of operated cryogenic refrigerators 310 increases. When a difference between a required temperature and a current internal temperature of the vacuum container 100 is not large or when the current internal temperature of the vacuum container 100 remains equal to the required temperature, the number of operated cryogenic refrigerators 310 decreases to reduce power consumption.

The pressure tank 400 is included in the closed system to serve to control an internal pressure. The pressure tank 400 controls the internal pressure by supplying and discharging gas-phase working fluid, and includes a pressure sensor 410 and a pressure gauge 420 for measuring a pressure, and a safety valve 430 provided for emergency.

The present disclosure uses a saturation curve of working fluid, based on the principle that the working fluid is liquefied at a relatively high temperature when gas is supplied to the pressure tank 400, that is, the closed system, to increase the pressure, and the working fluid is liquefied at a relatively low temperature when the gas in the closed system is discharged to decrease the pressure.

When the required temperature is lower than the current temperature, gas is discharged through the gas exhaust line 511 connected to the pressure tank 400. In this case, when a pressure lower than atmospheric pressure is required, a vacuum pump may be arranged. When the required temperature is higher than the current temperature, gas is supplied through the gas supply line 521 connected to the pressure tank 400 to increase the pressure in the closed system.

FIG. 5 is an enlarged view illustrating the pressure tank 400 and the control device 500. Referring to FIG. 5, the pressure tank 400 is connected to the gas exhaust line 511 connected to the outside and the gas supply line 521 connected to a bombe 600. A pressure is input to the control device 500 through the pressure sensor 410 of the pressure tank 400, and the control device 500 outputs whether to open or close an exhaust valve 510 of the gas exhaust line 511 and a supply valve 520 of the gas supply line 521.

A temperature required for the vacuum container 100, that is, a required space environment condition, is input to the control device 500, and the control device 500 controls the components of the present disclosure to implement a space environment. In order to match a saturation temperature of working fluid with the required space environment condition, a pressure of the pressure tank 400 is input to the control device 500 through the pressure sensor 410, and the control device 500 controls the pressure by opening or closing the exhaust valve 510 and the supply valve 520.

In this case, the feature of the present disclosure is not limited to the saturation temperature of the working fluid being matched with the required temperature, and the saturation temperature may be set to a temperature higher or lower than the required temperature to quickly reach the required temperature.

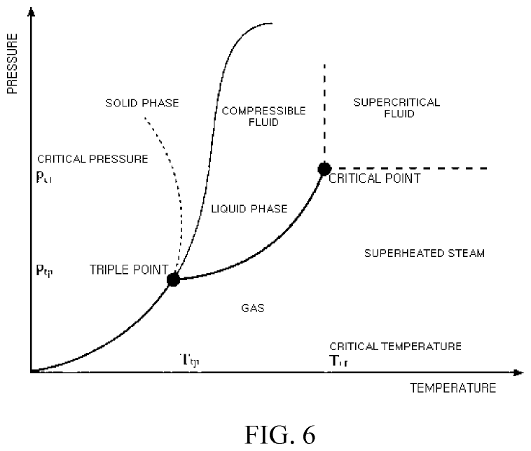

The control device 500 includes a calculation unit calculating a saturation temperature of working fluid through the pressure sensor 410 connected to the pressure tank 400. The control device 500 includes phase-change data about working fluid, controls the valves 510 and 520 based on the phase-change data, and forms a pressure of the closed system corresponding to the saturation temperature of the working fluid. The phase-change data will be described with reference to FIG. 6 below.

In addition, the control device 500 may be connected to one or more cryogenic refrigerators 310 to control the number of cryogenic refrigerators 310 that need to be operated and an operation time thereof in consideration of the required temperature and a time required to reach the set temperature.

In addition, the control device 500 is connected to the plurality of temperature sensors 230 disposed along the shroud 200 to control a pressure with temperature-change data according to the movement of the working fluid input thereto from the temperature sensors 230.

That is, when a temperature required for the vacuum container 100 is input, the calculation unit of the control device 500 may derive an estimated time by obtaining current information through the temperature sensors 230 and the pressure sensor 410 and controlling the plurality of valves and the number of cryogenic refrigerators 310 to be operated.

Recalling the problem of the conventional art, if a cryogenic bombe 600 containing liquefied fluid is connected, it is difficult to handle and manage the cryogenic bombe 600. In the present disclosure, however, the bombe 600 contains gas-phase working fluid at room temperature, and the bombe 600 is connected to the pressure tank 400 to supply the working fluid to the pressure tank 400. The working fluid is supplied to the shroud 200 after being liquefied in the cryogenic refrigerator 310 provided inside the liquefaction tank 300.

FIG. 6 is a general phase-change graph. Referring to FIG. 6, the range in which working fluid is liquefied to be supplied into the shroud refers to a range between a triple point temperature and a critical point temperature of the working fluid. A space environment is implemented by providing a pressure in a range between a triple point pressure and a critical point pressure according to the temperatures for the respective points. For example, in a case where nitrogen is selected and supplied as working fluid, a triple point temperature of nitrogen is −210° C., and a triple point pressure of nitrogen is 12.53 kPa. In addition, a critical point temperature of nitrogen is −146.96° C., and a critical point pressure of nitrogen is 3.3978 MPa. The control device forms a pressure of 12.53 kPa to 3.3978 MPa by controlling the exhaust valve and the supply valve, and forms a temperature of −210° C. to −146.96° C. in the vacuum container through the liquefied working fluid.

### [2] Method for Implementing Space Environment According to Present Disclosure

A method for implementing a space environment using the device for implementing a cryogenic space environment according to the present disclosure having the above-described features will be described with reference to FIG. 2.

The method for implementing a space environment using the device for implementing a space environment includes: a pressure control step in which the control device 500 controls a pressure of the closed system by supplying or discharging fluid to or from the pressure tank 400; after the pressure control step, a liquefaction step in which the cryogenic refrigerator 310 liquefies the supplied working fluid; after the liquefaction step, an inflow step in which the liquefied working fluid moves in a gravity direction and flows into the shroud 200; and after the inflow step, a heat exchange step in which radiant heat is exchanged between the shroud 200 and the inside of the vacuum container 100.

The pressure control step is a step in which a pressure of the closed system is input to the control device 500, and the control device 500 controls the exhaust valve and the supply valve to be opened or closed. The control device 500 adjusts an internal pressure to a required pressure by supplying or exhausting gas-phase working fluid through the exhaust valve and the supply valve.

In addition, the pressure control step includes: a depressurization step in which the working fluid is discharging to the outside to decrease the pressure in the closed system; and a pressurization step in which working fluid for pressurization is supplied from the bombe 600 containing the working fluid at room temperature to increase the pressure in the closed system. In the depressurization step, gas-phase working fluid is discharged to the outside through the exhaust valve, and if necessary, the pressure in the closed system is decreased by using a pump. In the pressurization step, if necessary, a pressurizing device is provided or a plurality of bombes 600 are connected for pressurization.

The liquefaction step is a step in which the gas-phase working fluid is liquefied under the pressure adjusted in the pressure control step. The gas-phase working fluid supplied to the closed system is liquefied by one or more cryogenic refrigerators 310 provided in the liquefaction tank 300. At this time, a temperature of the liquefied working fluid is equal to a saturation temperature, and the liquefied working fluid is formed as working fluid having a temperature corresponding to the pre-adjusted pressure. The pressure decreased by liquefaction or increased by vaporization is continuously adjusted in the control device 500.

The inflow step is a step in which the liquefied working fluid is transferred in the gravity direction and supplied into the shroud 200. The liquefaction tank 300 is disposed above the shroud 200, and the liquid line through which the liquefied working fluid is supplied is disposed at the lower surface or the lower end of the liquefaction tank 300, such that the liquefied working fluid is supplied into the shroud 200 without applying additional force.

The heat exchange step is a step in which the working fluid supplied into the shroud 200 exchanges heat with the inside of the vacuum container 100. At this time, the exchange of the heat is exchange of radiant heat, and a space environment having a required temperature is created through the heat exchange.

After the heat exchange step, the method for implementing a space environment further includes a recycling step in which the working fluid subjected to the heat exchange is vaporized, the vaporized working fluid moves to the liquefaction tank 300, and then the liquefaction step is repeated. The liquefied working fluid supplied into the shroud 200 is vaporized through the heat exchange and transferred to the liquefaction tank 300 through the gas line. The transferred gas-phase working fluid is liquefied by the cryogenic refrigerator 310, and the liquefied working fluid is supplied to the shroud 200. The closed system has a circulation structure in the following order: the liquefaction tank, the liquid line, the shroud, the gas line, and the liquefaction tank, which may reduce an amount of working fluid to be consumed. The gas line is connected to the upper end or the upper surface of the liquefaction tank 300 to prevent the liquefied working fluid from moving.

The method for implementing a space environment according to the present disclosure includes: before the pressure control step, a condition input step in which a required temperature condition is input to the control device 500; and after the condition input step, a calculation step in which how much the pressure is to be adjusted is calculated to implement the required temperature according to the input required temperature condition.

In the condition input step, a pressure and a temperature in the vacuum container 100 are input. The required pressure is implemented through the vacuum pump 110 connected to the vacuum container 100, and the required temperature is implemented through heat exchange with the shroud 200 disposed inside the vacuum container 100.

In order to implement the required temperature, the calculation step includes a calculation unit having phase-change data about the supplied working fluid. The calculation unit calculates whether to open or close the plurality of valves and the number of cryogenic refrigerators 310 to be operated, and drives each component through the control device 500.

In addition, the calculating unit may estimate a time required to reach the required pressure and temperature through the temperature sensors 230 and the pressure sensor 410 and based on the specifications of each component.

The present disclosure may be modified in various ways and may have various embodiments. Although specific embodiments have been illustrated in the drawings and described in detail above, it should be understood that the present disclosure is not limited to the specific embodiments, but covers all modifications, equivalents or substitutes that fall within the spirit and scope of the present disclosure.

Also, it should be understood that when one component is referred to as being “coupled” or “connected” to another component, the one component may be coupled or connected to the another component either in a direct manner or through an intervening component.

Unless defined otherwise, all terms used herein, including technical or scientific terms, have the same meanings as commonly understood by those having ordinary skill in the art to which the present disclosure pertains.

Terms such as those defined in generally used dictionaries should be interpreted to have meanings consistent with the contextual meanings in the relevant art, and are not to be interpreted to have ideal or excessively formal meanings unless clearly defined in the present application.

The present disclosure is not limited to the above-described embodiments, and may be applied in a wide range. Also, various modification may be made without departing from the gist of the present disclosure described herein.

### DETAILED DESCRIPTION OF MAIN ELEMENTS

100: Vacuum container
110: Vacuum pump
200: Shroud
210: Gas line
220: Liquid line
230: Temperature sensor
300: Liquefaction tank
310: Cryogenic refrigerator
320: Connection line
400: Pressure tank
410: Pressure sensor
420: Pressure gauge
430: Safety valve
500: Control device
510: Exhaust valve
511: Gas exhaust line
520: Supply valve
521: Gas supply line
600: Bombe

1. A device for implementing a space environment, the device comprising:
a vacuum container maintaining a vacuum state through a vacuum pump;
a shroud disposed inside the vacuum container to exchange heat between working fluid supplied into the shroud and the inside of the vacuum container;
a liquefaction tank connected to both ends of the shroud and including a cryogenic refrigerator liquefying working fluid;
a pressure tank connected to an upper end of the liquefaction tank to supply or discharge gas-phase working fluid to or from the liquefaction tank; and
a control device controlling a pressure of the pressure tank, by supplying or discharging working fluid to or from the pressure tank, to adjust a saturation temperature of the working fluid.

2. The device of claim 1, wherein a closed system is maintained inside the shroud, and radiant heat is exchanged between the working fluid supplied into the shroud and the inside of the vacuum container.

3. The device of claim 2, wherein the liquefaction tank is connected to both ends of the shroud, including:
a gas line connected to the upper end of the liquefaction tank to supply vaporized working fluid from the shroud to the liquefaction tank; and
a liquid line connected to a lower end of the liquefaction tank to supply liquefied working fluid from the liquefaction tank to the shroud,
the liquefaction tank is disposed above the shroud, and
the liquefied working fluid moves in a gravity direction and is injected into the shroud.

4. The device of claim 3, wherein a plurality of temperature sensors are disposed along the shroud in the vacuum container, and
the plurality of temperature sensors are disposed to be spaced apart from one another at predetermined intervals from the liquid line to a lower side of the shroud to measure a location-based change in temperature of working fluid.

5. The device of claim 4, wherein one or more cryogenic refrigerators are disposed in the liquefaction tank, and
The one or more cryogenic refrigerators are controlled according to an internal temperature of the vacuum container.

6. The device of claim 1, wherein gas-phase working fluid is supplied from a bombe to the pressure tank to increase an internal pressure of the pressure tank.

7. The device of claim 6, wherein the pressure tank is connected to an exhaust line connected to the outside and a supply line connected to the bombe, and
the pressure of the pressure tank is input to the control device, and the control device outputs whether to open or close an exhaust valve of the exhaust line and a supply valve of the supply line.

8. The device of claim 6, wherein the bombe contains nitrogen gas at room temperature.

9. The device of claim 1, wherein the control device includes a calculation unit calculating the saturation temperature of the working fluid through a pressure sensor connected to the pressure tank.

10. The device of claim 2, wherein the shroud maintains a temperature of the working fluid in a range between a triple point temperature and a critical temperature by adjusting a saturation pressure of the fluid in the closed system.

11. A method for implementing a space environment using the device of claim 2, the method comprising:
a pressure control step in which the control device controls a pressure of the closed system by supplying or discharging fluid to or from the pressure tank;
after the pressure control step, a liquefaction step in which the cryogenic refrigerator liquefies the supplied working fluid;
after the liquefaction step, an inflow step in which the liquefied working fluid moves in a gravity direction and flows into the shroud; and
after the inflow step, a heat exchange step in which radiant heat is exchanged between the shroud and the inside of the vacuum container.

12. The method of claim 11, wherein the pressure control step includes:
a depressurization step in which the working fluid is discharged to the outside to decrease the pressure in the closed system; and
a pressurization step in which working fluid for pressurization is supplied from a bombe containing the working fluid at room temperature to increase the pressure in the closed system.

13. The method of claim 11, wherein in the liquefaction step, the saturation temperature of the working fluid is changed according to the pressure adjusted in the pressure control step.

14. The method of claim 11, further comprising, after the heat exchange step, a recycling step in which the working fluid subjected to the heat exchange is vaporized, the vaporized working fluid moves to the liquefaction tank, and then the liquefaction step is repeated.
